(19) United States
(12) Patent Application Publication
(10) Pub. No.: US 2024/0119416 A1
(43) Pub. Date: Apr. 11, 2024

(54) SYSTEM AND METHOD FOR TEAM ANALYSIS AND RECOMMENDATION

(71) Applicant: BILLD, LLC, AUSTIN, TX (US)

(72) Inventor: Christopher Lee Doyle, Austin, TX (US)

(21) Appl. No.: 18/378,556

(22) Filed: Oct. 10, 2023

Related U.S. Application Data
(60) Provisional application No. 63/414,810, filed on Oct. 10, 2022.

(51) Int. Cl. G06Q 10/10

(52) U.S. Cl. CPC G06Q 10/103

(57) ABSTRACT

Methods and systems for team analysis and recommendation are disclosed. In some examples, a recommendation system receives team data corresponding to a team (e.g., including contractor(s)) associated with a project, including project history information associated with prior project(s) worked on by the contractor(s) before the project. The recommendation system analyzes the team data to generate a confidence score that represents an estimated level of confidence in an ability of the team to fulfill a specified obligation type. The recommendation system identifies, based on the team data and the confidence score, a recommended offer for assisting the team (e.g., the contractor(s)) with aspect(s) of the project. The recommended offer includes obligation(s) of the specified obligation type. The obligation(s) are customized for the team based on the confidence score. The recommendation system sends the recommended offer to a user device to request that the user device present the recommended offer.

### CROSS-REFERENCE TO RELATED APPLICATIONS

This application claims the benefit of U.S. Provisional Application No. 63/414,810, filed Oct. 10, 2022, titled “System and Method for Selecting Clients to Present a Credit Offer Within a Construction Management Platform,” the disclosure of which is incorporated herein by reference in its entirety.

### FIELD OF THE DISCLOSURE

Exemplary embodiments of the subject disclosure relate generally to a system and a method for generating a credit offer, and more particularly related, to a system and a method for selecting clients to present a credit offer client for a construction project based on attributes of the client.

### BACKGROUND

Construction projects can, in some cases, use loans or credit lines to finance aspects of a construction project. In some cases, a different teams (e.g., contractor(s) and/or owner(s) associated with a project) may be associated with different projects. Some teams and/or projects may be more trustworthy or risky than others.

### SUMMARY

Methods and systems for team analysis and recommendation are disclosed. In some examples, a recommendation system receives team data corresponding to a team (e.g., including contractor(s)) associated with a project. The team data includes project history information associated with prior project(s) worked on by the contractor(s) before the project. The recommendation system analyzes the team data to generate a confidence score associated with the team. The confidence score represents an estimated level of confidence in an ability of the team to fulfill a specified obligation type. The recommendation system identifies, based on the team data and the confidence score, a recommended offer for assisting at least a subset of the team (e.g., the contractor(s)) with at least an aspect of the project. The recommended offer includes obligation(s) of the specified obligation type. The obligation(s) are customized for the team based on at least the confidence score. The recommendation system sends the recommended offer to a user device to request that the user device present the at least one recommended offer.

In some examples, a method for presenting a credit offer to a client within a construction management platform. In one embodiment, the method for presenting a credit offer to the client comprising receiving data related to the client. The client is at least one of a property owner, a general contractor, and a sub-contractor. In one embodiment, the client is referred as a sub-contractor. The credit offer is presented only to a qualified sub-contractor after evaluating multiple attributes related to the sub-contractor, a general contractor, a property owner, and a project. It can be noted that the multiple attributes include, but not limited to, annual revenue of the general contractor, annual revenue of the sub-contractor, project worth, trade of the sub-contractor, lien history of the sub-contractor, trade history of the sub-contractor. Further, the method comprises receiving data related to the client. Based on the received data, the data may include options for financial and business attributes related to the client. Further, the method comprises calculating a confidence score based on the received data of the client. The confidence score can be referred to as a risk score, a safety score, a danger score, a hazard score, a score, or a combination thereof. It can be noted that the confidence score represents the ability of the client to fulfill their obligations of the credit offer. Further, the method comprises of presenting a credit offer to the client based on the confidence score of the client. It can be noted that the offer is received after the confidence score of the sub-contractor and the project is evaluated. It can be noted that the credit offer is presented within a software platform used by the general contractor or sub-contractor. For example, the base module receives a prequalified offer of $50,000 to get qualified for the plumbing trade on the parking garage of worth $20,000,00. Further, the method comprises displaying lien data of the project and trade of sub-contractor. For example, the base module displays that Alex receives the offer of $50,000 for the plumbing trade on the parking garage of worth $20,000,00, with the pay advance offer of $25,000.

Further, the method comprises calculating a confidence score based on the received data of the client. It can be noted that the confidence score may be calculated from previous trade projects and delayed payments. For example, the base module retrieves that the sub-contractor Alex is offered with a plumbing trade on a parking garage of worth $20,000,00, based on a risk factor of sub-contractor Alex with credit score—740, lien data parking garage worth of $10,00,000, annual revenue of sub-contractor $3 million, annual revenue of general contractor $3 million, trade of sub-contractor as plumbing, and payment performance of timely paid. In one embodiment, the construction management platform evaluates what should be the offer presented to the sub-contractor before actually presenting the credit offer. Further, the construction management platform provides a payment gateway after the property owner selects the sub-contractor or the sub-contractor for the project. It can be noted that the payment gateway is presented to the sub-contractor for payment of purchased materials for the trade.

In one embodiment, the method comprises determining materials to be offered to the sub-contractor, based on the determined risk. Finally, the method comprises displaying the credit offer to the client.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a system for presenting a credit offer to a client for a construction project, in accordance with some examples.

FIG. 2 illustrates a block diagram of a base module for presenting a credit offer to a client within a construction management platform, in accordance with some examples.

FIG. 3 illustrates an exemplary credit network database, in accordance with some examples.

FIG. 4 is a flow diagram illustrating a process for presenting a credit offer to a client for a construction project, in accordance with some examples.

FIG. 5 is a flow diagram illustrating a process for training of one or more machine learning (ML) model(s), inference(s) generated using the ML model(s), and/or updating of the ML model(s) as part of the present technology, in accordance with some examples.

FIG. 6 is a flow diagram illustrating a process for for team analysis and recommendation, in accordance with some examples.

FIG. 7 is a block diagram of an exemplary computing device that may be used to implement some aspects of the technology.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It is to be understood that the figures and descriptions of the present disclosure have been simplified to illustrate elements that are relevant for a clear comprehension of the present disclosure, while eliminating, for the purpose of clarity, many other elements found in systems and methods of utilizing a mechanic's lien to implement an adjustment. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the present disclosure, the preferred methods and materials are described. As used herein, each of the following terms has the meaning associated with it in this section. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Ranges: throughout this disclosure, various aspects of the disclosure can be presented in a range format. It should be understood that the description in range format is merely for convenience and brevity and should not be construed as an inflexible limitation on the scope of the disclosure. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. “About” as used herein when referring to a measurable value such as an amount, a temporal duration, and the like, is meant to encompass variations of ±20%, ±10%, ±5%, ±1%, and ±0.1% from the specified value, as such variations are appropriate.

Referring now in detail to the drawings, in which like reference numerals indicate like parts or elements throughout the several views, in various embodiments, presented herein is a system and method for presenting a credit offer to a client for a construction project at designated instances that represent time of need. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Borrowers borrowing money to make purchases apply for a loan in one of several ways. For example, a borrower may apply through a lender or an individual representing the lender or may submit an application electronically over the Internet. Loans are available from many different sources, such as traditional banks, private and commercial money lenders. Further, lending institutions, such as banks, have assessed loan risk using credit reports and/or credit scores. Credit reports are records sent from a credit reporting agency to prospective lenders, employers, and insurers that provide information about the credit standing of a consumer. Credit reporting agencies are companies that gather the information about consumers and sell it to creditors and/or employers and/or insurers.

Traditional financial instruments, for establishing credit offers, facilitate lenders to evaluate factors like—credit score, income, age of credit, outstanding debt, historical payment performances, and asset recovery value related to the borrower. A credit score often refers to a number generated by a statistical model that is used to objectively evaluate the credit worthiness of the borrower(s) (including borrower's income) relevant to making a credit decision. In particular, income of the borrower is money that a borrower or a business receives in return for working, providing a product or service, or investing capital. Income may also derive from a pension, a government benefit, or a gift. Further, age of credit or length of credit history may be referring to how long any account has been open. In addition, the outstanding debt is defined as the total principal as well as interest amount of a debt that has yet to be paid, is of core importance for any company which has used debt financing. The outstanding debt is important because it expresses a dollar amount to be paid before a liability is closed. Further, historical payment performances refer to the pattern or the percentage of payments made in the past, related to the borrower. Furthermore, the asset recovery value is the projected value of an asset that can be recovered in the event of liquidation or winding down. The asset recovery value is calculated as the recovery rate times the book value of the asset.

Further, a mechanic's lien is a legal claim against a property may be used by the lender, in case the lender is not paid. The mechanic's lien provides lien rights to the lender against the property as a security interest in case the lender remains unpaid. The mechanic's lien enables the lender to enforce a foreclosure action on the borrower's property and receive due payment. In the case of the government project, the lender can make a bond claim, which is a sum of money reserved to protect security against payment disputes on the project. Generally, the lien rights are available to the lenders who provide loans or materials for any construction project. These lenders possess the lien rights only by virtue of working on or contributing materials to a construction project. The mechanic's lien is a powerful tool to claim the paid debt, however, the right of filing the mechanic lien gets expired in lack of opting the correct steps to preserve it. Since the mechanic's lien requires the lenders to take specific actions disclosed in state law to preserve their lien rights. In case, the lenders fail to take the right steps at the right time, the lenders may lose their right to file a mechanics lien. Since, the process to preserve the lien rights is driven by very strict deadlines and sending the notices within the time frames are other required factors, skipping any step or operation during the process may lead to loss of lien rights. Further, the presence of liens related to a contractor is a negative factor that would lower the credit offer of the contractor.

The above mentioned methods are quite useful but can be suboptimal in some situations due to the narrow focus of a fixed credit offer and no contribution of project status and other factors such as rate and term. Traditional financial instruments inefficiently evaluate the credit to be given to the borrower. Therefore, there is a need for an improved system and method for implementing adjustments to financial instruments, particularly a method for establishing a variable credit offer for a selected client based on attributes of the client.

Methods and systems for team analysis and recommendation are disclosed. In some examples, a recommendation system receives team data corresponding to a team (e.g., including contractor(s)) associated with a project. The team data includes project history information associated with prior project(s) worked on by the contractor(s) before the project. The recommendation system analyzes the team data to generate a confidence score associated with the team. The confidence score represents an estimated level of confidence in an ability of the team to fulfill a specified obligation type. The recommendation system identifies, based on the team data and the confidence score, a recommended offer for assisting at least a subset of the team (e.g., the contractor(s)) with at least an aspect of the project. The recommended offer includes obligation(s) of the specified obligation type. The obligation(s) are customized for the team based on at least the confidence score. The recommendation system sends the recommended offer to a user device to request that the user device present the at least one recommended offer.

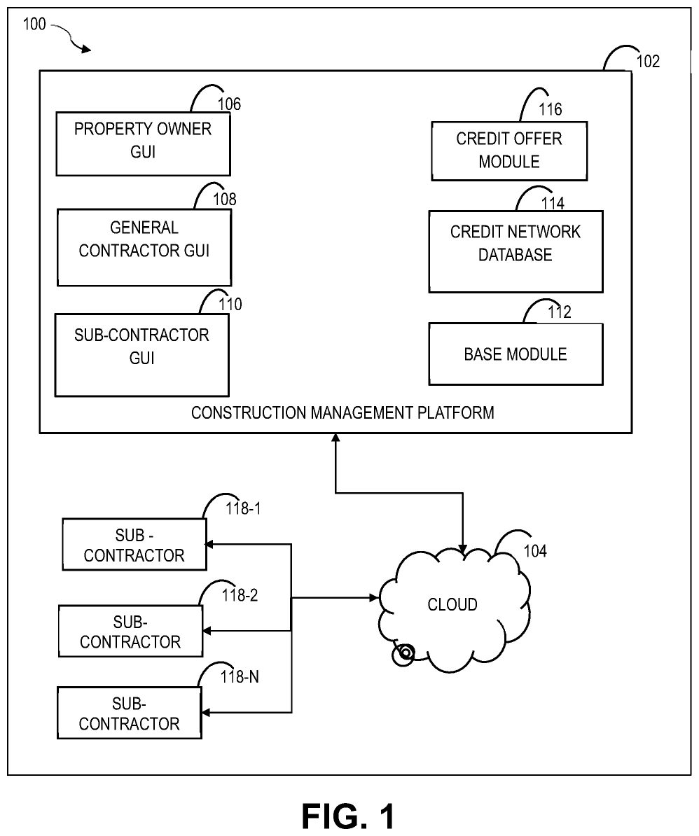

FIG. 1 illustrates a system 100 for presenting a credit offer to a client for a construction project, according to an embodiment. In one embodiment, the client may be a sub-contractor, a general contractor, or a property owner. The system 100 may comprise a construction management platform 102 and a cloud 104. Further, the construction management platform 102 may comprise a property owner graphical user interface (GUI) 106, a general contractor GUI 108, a sub-contractor GUI 110, a base module 112, a credit network database 114, and a credit offer module 116. Further, the system 100 may comprise one or more sub-contractors 118-1 . . . 118-N. It can be noted that the one or more sub-contractors 118-1 . . . 118-N may be in communication with the construction management platform 102 via the cloud 104. Hereinafter, the one or more sub-contractors 118-1 . . . 118-N may be referred to as a sub-contractor 118. In one embodiment, the construction management platform 102 may be used to implement the methods described herein that presenting a credit offer to a client for a construction project at designated instances that represent time of need. It can be noted that the client receiving the credit offer may be the sub-contractor 118. It can also be noted that a plurality of sub-contractors may work under a general contractor and further the general contractor may work under the property owner. In one embodiment, a property owner may be a company that who owns the property at which the construction project is occurring. Further, a general contractor may work for the property owner and may hire subcontractors and manage their interactions with the property owner and other parties. Furthermore, the sub-contractor may work for general contractor and may specialize in a specific trade like at least one of drywall, painting, and plumbing.

Further, the cloud 104 may be implemented for connecting various devices/components in the system 100. The cloud 104 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The cloud 104 may allow ubiquitous access to shared pools of configurable resources and higher-level services that can be rapidly provisioned with minimal management effort, often over the internet and relies on sharing of resources to achieve coherence and economies of scale, like a public utility, while third-party clouds enable organizations to focus on their core businesses instead of expending resources on computer infrastructure and maintenance. The cloud 104 may also use standard architecture and protocols as understood by those skilled in the art, such as, for example, a packet switched network for transporting information and packets in accordance with a standard transmission control protocol/Internet protocol (“TCP/IP”). Additionally, the system 100 may utilize any conventional operating platform or combination of platforms (Windows, Mac OS, Unix, Linux, Android, etc.) and may utilize any conventional networking and communications software as would be understood by those skilled in the art. Additionally, the cloud 104 may be communicatively coupled to the one or more computing devices and the credit network database 114, to facilitate the system 100 for adjusting the credit limit based on lien data of the sub-contractor 118.

Further, the cloud 104 may facilitate sharing data of the one or more sub-contractors 118. Thus, to protect data of the sub-contractor 118, such as sensitive user financial and personal identification data, government data related to the construction or site plans, other confidential data, and to comply with state and federal laws pertaining to protection of financial and personal identification data, an encryption standard may be used to protect files from unauthorized interception over the network. Any encryption standard or authentication method as may be understood by those having ordinary skill in the art may be used at any point in the system of the present disclosure. For example, encryption may be accomplished by encrypting an output file by using a Secure Socket Layer (SSL) with dual key encryption. Additionally, the system may limit data manipulation, or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of user names and passwords required for use of the system run a check for or to implement an adjustment, backend administrative access, associated mobile device apps, or the selection of one or more data types that the subservient user is allowed to view or manipulate.

In one embodiment, the property owner GUI 106 may be a user device graphical user interface (GUI) or guided user interface(s) that may either accept inputs from property owners or facilitate outputs to the property owners, or may perform both the actions of input and output. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface. It can be noted that the property owner may be a company having a requirement of a specific trade from the sub-contractor. In one embodiment, the property owner GUI 106 may present the company requiring special assistance, credit size and credit history of the one or more sub-contractors 118.

Further, the general contractor GUI 108 may be a user device graphical user interface (GUI) or guided user interface(s) that may either accept inputs from general contractors or facilitate outputs to the general contractors, or may perform both the actions of input and output. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface.

The sub-contractor GUI 110 may be a user device graphical user interface (GUI) or guided user interface(s) that may either accept inputs from sub-contractors or facilitate outputs to the sub-contractors, or may perform both the actions of input and output. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface.

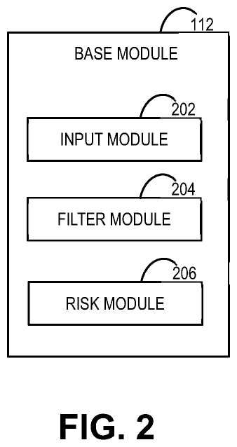

The base module 112 may provide function of presenting a credit offer to the sub-contractor 118 for a construction project at designated instances that represent time of need. The base module 112 may also perform filtering of the contractor data from the credit network database 114. Further, the base module 112 may be responsible for determining the risk associated with the lien provided by the sub-contractor 118, in light of the credit offer. Further, the base module 112 may facilitate sending mails to the sub-contractor 118, with information related to the lien data associated with the sub-contractor 118. It can be noted that the base module 112 may be explained in FIG. 2.

FIG. 2 illustrates a block diagram of the base module 112 for practicing embodiments of the method for presenting a credit offer to the sub-contractor 118 for a construction project at designated instances that represent time of need. The base module 112 may comprise an input module 202, a filter module 204, and a risk module 206. In one embodiment, the input module 202 may facilitate receiving information from the one or more sub-contractors 118. It can be noted that the information received from the one or more sub-contractors 118 may include name of the sub-contractor 118, contractor identification number (CIN), credit score, years in business, annual revenue, trade of contract, lien data, credit offer, payment performance. For example, the input module 202 receives the information of the sub-contractor Alex from the credit network database 114 as CIN—717, credit score—740, years in business—5 years, annual revenue—$3 million, and types of project—building construction, payment performance—loan L1 with a total amount of $4 million and failure to repay an earlier credit of $4 million to Lender 1 on time, credit offer of $10,00,000, and lien data for 73 Kings Street, London including the failure to repay an earlier credit of $4 million to Lender 1. Further, the information received from the one or more sub-contractors 118-1 . . . 118-N may be stored in the credit network database 114.

Further, the filter module 204 may facilitate filtering information from the credit network database 114, based on one or more predefined filtering parameters. In one embodiment, the one or more predefined filtering parameters may be associated with a particular sub-contractor (of the one or more sub-contractors 118-1 . . . 118-N), a particular general contractor, or a particular property owner. For example, the filter module 204 filters information related to Alex. In another embodiment, the one or more predefined filtering parameters may be sub-contractors which have lien above a particular limit. For example, for having a single lien value or data available. Further, the risk module 206 may facilitate calculating a risk at the time when a loan is made and the risk may further determine parameter, not limited to, the loan interest rate, payment schedules, and penalties. For example, for Alex with an initial loan applied for $10,00,000 and the credit offer of $10,00,000 and lien data for 73 Kings Street, London including a failure to repay an earlier credit of $4 million to Lender 1 on time, the risk module 206 calculates that the associated risk is high. It can be noted that more the lien, lesser would be the risk for the lender for providing the loan, or visa-versa.

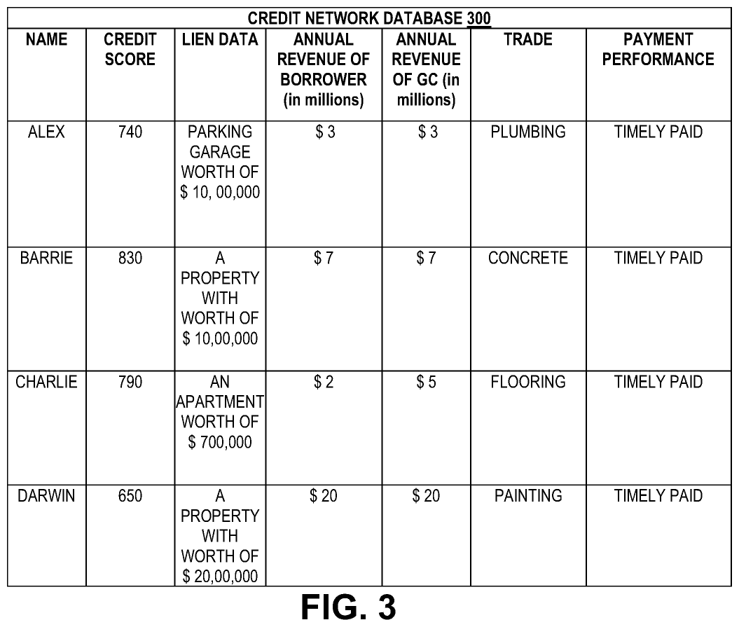

In one embodiment, the credit network database 114 may be used to store data related to the one or more sub-contractors 118. The credit network database 114 may include structured data of all the sub-contractors and sub-contractors in terms of their profiles, their contract for credit for materials, lien data in the contracts of when liens can be levied. In one embodiment, the data may include at least but not limited to credit score, years in business, annual revenue, type of project, payment performance, average project score, criminal history, civil judgments, outstanding debts, and lien history of the one or more sub-contractors 118. Further, the credit network database 114 may be configured to store a systematic collection of data used for electronic storage and manipulation of data. In one embodiment, the credit network database 114 may be of various types such as but not limited to centralized database, cloud database, and network database. It can be noted that the information stored in the credit network database 114 may reflect a robust picture of the sub-contractor's business and financial soundness. There are no limitations to the number, type or connectivity of the credit network database 114 utilized by the system 100. It can be noted that an exemplary credit network database 114 may be shown in FIG. 3.

For example, the credit network database 114 as shown in FIG. 3 includes, the information of the sub-contractor Alex with credit score—740, lien data parking garage worth of $10,00,000, annual revenue of sub-contractor $3 million, annual revenue of general contractor $3 million, trade of sub-contractor as plumbing, and payment performance of timely paid. Further, the credit network database 114 includes the information of the sub-contractor Barrie with credit score—830, lien data of property worth of $10,00,000, annual revenue of sub-contractor $7 million, annual revenue of general contractor $7 million, trade of sub-contractor as concrete, and payment performance of timely paid. Further, the credit network database 114 includes the information of the sub-contractor Charlie with credit score—790, lien data of an apartment worth of $7,00,000, annual revenue of sub-contractor $2 million, annual revenue of general contractor $5 million, trade of sub-contractor as flooring, and payment performance of timely paid. Further, the credit network database 114 includes the information of the sub-contractor Darwin with credit score—650, lien data of property worth of $20,00,000, annual revenue of sub-contractor $20 million, annual revenue of general contractor $20 million, trade of sub-contractor as painting, and payment performance of timely paid. In one embodiment, the lien information may be related to a lien activity on a construction project, which represents a collections risks to lenders for the construction project. Further, the credit offer module 116 may be responsible for presenting a credit offer to the contractor 118 for a construction project at designated instances that represent time of need. It can be noted that the lien data of the sub-contractor 118 may be initially provided by the sub-contractor 118.

In one embodiment, the sub-contractor 118 may be using one or more computing devices, for connecting to the cloud 104. It can be noted that the one or more computing devices may be a computing device, desktop, laptop, smartphone, table, computer, smart speaker, smartphones, other wireless digital/cellular devices, or I/O devices. Hereinafter, the one or more computing devices may be referred to as a computing device. The computing device may comprise an input device and an output device. The input device may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output device may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands, devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality including, e.g., pinch, spread, rotate, scroll, or other gestures.

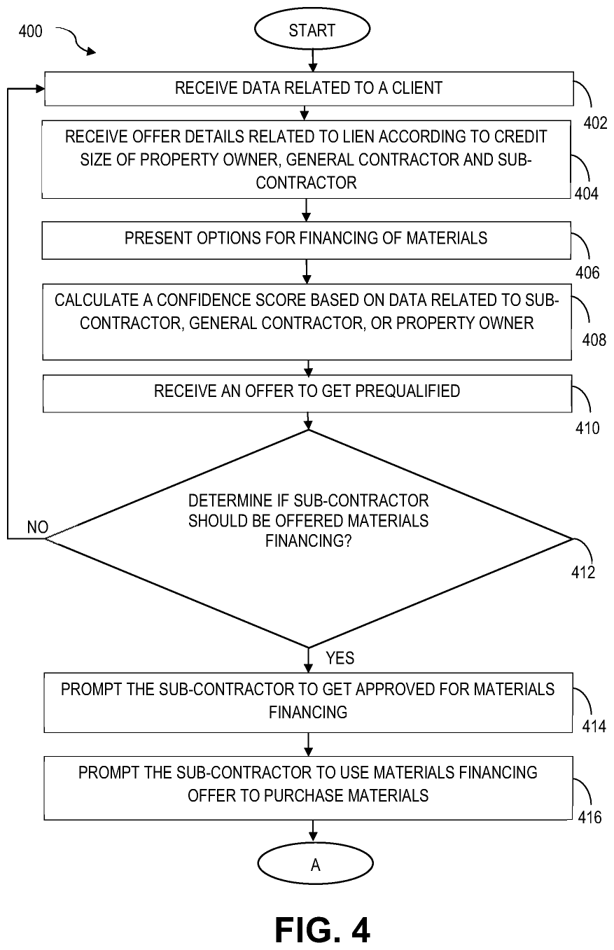

FIG. 4 is a flow diagram illustrating a process 400 for presenting a credit offer to a client for a construction project, according to an embodiment. It should also be noted that in some alternative implementations, the functions noted in the blocks may occur out of the order noted in the drawings. For example, the blocks shown in succession in FIG. 4 may be executed substantially concurrently or the blocks may sometimes be executed in the reverse order, depending upon the functionality involved. In addition, the process descriptions or blocks in flowcharts should be understood as representing decisions made by a hardware structure such as a state machine.

At first, the base module 112 may receive data related to the client, at operation 402. In one embodiment, the client may be sub-contractor, general contractor, or property owner. Further, the data may be received from the credit network database 114. In one embodiment, the credit size of the lien may vary according to credit history of a sub-contractor, risk factor associated with lien of the sub-contractor. For example, the base module 112 retrieves credit size of a sub-contractor Alex with credit score—740, lien data parking garage worth of $10,00,000, annual revenue of sub-contractor $3 million, trade of sub-contractor as plumbing, and payment performance as timely paid.

Further, the base module 112 may receive offer details related to lien according to credit size of the property owner, the general contractor, and the sub-contractor 118, at operation 404. In one embodiment, the offer details may depend upon the credit size, such that the sub-contractor with higher credit size may receive an offer with a higher budget. For example, the base module 112 receives that the sub-contractor Alex with a credit score of 740 is offered with a plumbing trade of $10,000 on a parking garage of worth $20,000,00. Further, the base module 112 may present options for financing of materials, at operation 406. In one embodiment, the base module 112 may present options for materials financing to the sub-contractor over the sub-contractor GUI 110. For example, the base module 112 presents $10,000 option to Alex, after receiving the plumbing trade on the parking garage of worth $20,000,00.

Further, the base module 112 may calculate a confidence score based on data related to sub-contractor, general contractor, or property owner, at operation 408. For example, the base module 112 determines that for Alex with plumbing trade on a parking garage of worth $20,000,00, there is no risk due to timely payment by Alex.

Further, the base module 112 may receive an offer to get prequalified, at operation 410. In one embodiment, the offer may be presented only to a qualified sub-contractor after evaluating multiple attributes related to the sub-contractor 118, the general contractor, the property owner, and the project. It can be noted that the multiple attributes include, but not limited to, annual revenue of the general contractor, annual revenue of the sub-contractor 118, project worth, trade of the sub-contractor, lien history of the sub-contractor 118, trade history of the sub-contractor 118. For example, the base module 112 receives an offer of $50,000 to get qualified for the plumbing trade on the parking garage of worth $20,000,00.

Further, the base module 112 may determine if the sub-contractor 118 should be offered materials financing, at operation 412. In one case, the base module 112 may determine that the sub-contractor 118 should not be offered materials financing. In one embodiment, the base module 112 may evaluate what should be the offer presented to the sub-contractor 118 before actually presenting the materials financing offer. It can be noted that the sub-contractor 118 may be presented offer based on the annual revenue of the sub-contractor 118, project worth, trade of the sub-contractor 118, lien history of the sub-contractor 118, trade history of the sub-contractor 118. For example, the base module 112 determines that the credit network database 114 store that credit size of the sub-contractor Alex with credit score—740, lien data parking garage worth of $10,00,000, annual revenue of sub-contractor $3 million, trade of sub-contractor as plumbing, and payment performance of is not timely paid for a previous project of worth $2 million. In this case, the base module 112 is redirected to operation 402, to retrieve the credit size of lien from the credit network database 114. In another case, the base module 112 may determine that the sub-contractor 118 should be offered materials financing. For example, the base module 112 determines that the credit network database stores that credit size of the sub-contractor Barrie with credit score—830, lien data parking garage worth of $10,00,000, annual revenue of sub-contractor $7 million, trade of sub-contractor as concrete, and payment performance of is timely paid for a previous project of worth $4 million.

Further, the base module 112 may prompt the sub-contractor 118 to get approved for materials financing, at operation 414. For example, the base module 112 prompts the sub-contractor 118 to get $50,000 of finance approved for plumbing trade on the parking garage of worth $20,000,00.

Further, the base module 112 may prompt the sub-contractor 118 to use materials financing offer to purchase materials, at operation 416. For example, the base module 112 prompts the sub-contractor Alex to use the approved $50,000 of finance for purchasing materials for the plumbing trade on the parking garage of worth $20,000,00.

Further, the base module 112 may display the credit offer to the sub-contractor 118. The credit offer may include both product lines of build for material financing and Pay app financing. For example, the base module 112 displays that Alex receives the offer of $50,000 for the plumbing trade on the parking garage of worth $20,000,00, with the pay advance offer of $25,000.

The system and method for presenting a credit offer to a client for a construction project at designated instances that represent time of need may also include standard reporting mechanisms, such as generating a printable receipt of the transaction, or an electronic results report that can be transmitted to any communicatively connected computing device, such as a generated email message or file attachment. Likewise, particular results of the system transaction can trigger an alert signal, such as the generation of an alert email, text or phone call, to alert a user, financial institution or person associated with the user or financial institution. Further embodiments of such mechanisms are described below and according to standards of such systems understood by those skilled in the art.

The subject disclosure describes a method for presenting a credit offer to a client for a construction project at designated instances that represent time of need. It can be noted that the system 100 and method according to one embodiment may execute the method and algorithms for implementing an adjustment to a financial instrument which can include one or more local or remote executable software platforms, mobile device platforms, or a hosted Internet or network program or portal. In one embodiment, only portions of the system are computer operated, and in other embodiments, the entire system is computer operated. In one embodiment, client users may run an application on their mobile devices so that the system 100 can be easily accessed in real time at a construction site. The system and method for utilizing a mechanic's lien for implementing an adjustment is fully integral for use with any additional platform and data output that may be used for communicating with other platforms, such as for example financial institution platforms, user information platforms, cyber security platforms and payment collection platforms. Further, the method may be a continuous process as long as there is an outstanding balance in credit amount. Further, the credit may be frozen or limited, when a threshold number of liens come up.

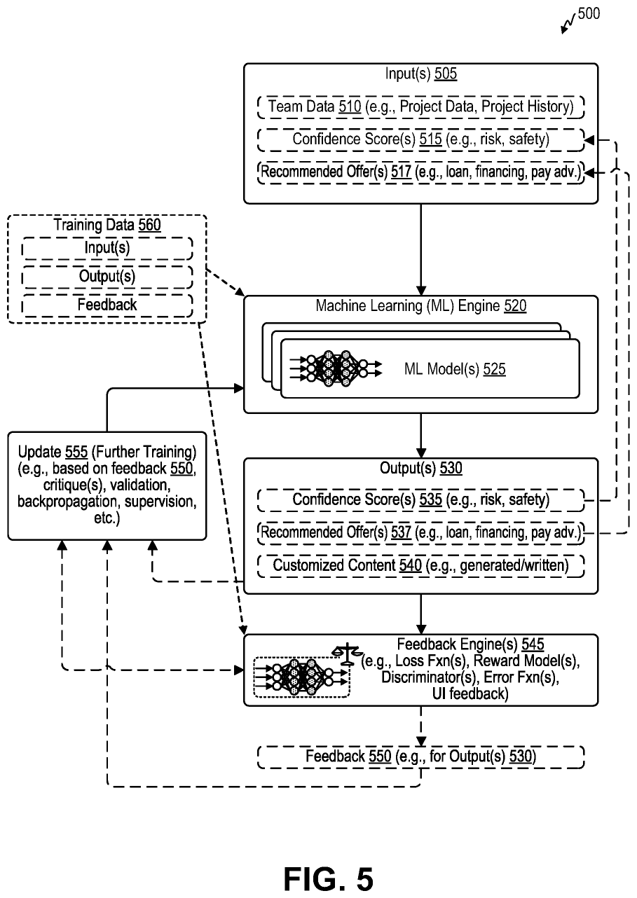

FIG. 5 is a flow diagram illustrating a process 500 for training of one or more machine learning (ML) model(s) 525, inference(s) generated using the ML model(s) 525, and/or updating of the ML model(s) 525 as part of the present technology.

In some examples, a recommendation system includes a machine learning (ML) engine 520 that generates, trains, uses, and/or updates the ML model(s) 525 as part of the process 500. The ML model(s) 525 can include, for instance, one or more neural network(s) (NN(s)), convolutional neural network(s) (CNN(s)), time delay neural network(s) (TDNN(s)), deep network(s) (DN(s)), autoencoder(s) (AE(s)), variational autoencoder(s) (VAE(s)), deep belief net(s) (DBN(s)), recurrent neural network(s) (RNN(s)), generative adversarial network(s) (GAN(s)), conditional generative adversarial network(s) (cGAN(s)), feed-forward network(s), network(s) having fully connected layers, trained support vector machine(s) (SVM(s)), trained random forest(s) (RF(s)), computer vision (CV) system(s), autoregressive (AR) model(s), Sequence-to-Sequence (Seq2Seq) model(s), large language model(s) (LLM(s)), deep learning system(s), classifier(s), transformer model(s), attention model(s), multi-head attention model(s), or a combination thereof. In examples where the ML model(s) 525 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 5, a graphic representing the ML model(s) 525 illustrates a set of circles connected to one another. Each of the circles can represent a node, a neuron, a perceptron, a layer or a portion thereof, or a combination thereof. The circles are arranged in columns, each column of which can represent a layer (e.g., a fully connected layer, a convolutional layer). The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 525 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 525 can include a feed-forward network, in which case there are no feedback connections where outputs of the network are fed back into itself. In some cases, the ML model(s) 525 can include a recurrent neural network, which can have loops that allow information to be carried across nodes while reading in input. In some cases, the network can include a convolutional neural network, which may avoid linking every node in one layer to every other node in the next layer.

One or more input(s) 505 can be provided to the ML model(s) 525. The ML model(s) 525 can be trained by the ML engine 520 (e.g., based on training data 560) to generate one or more output(s) 530. In some examples, the input(s) 505 include team data 510. The team data 510 can include, for instance, information associated with (and/or stored on) the construction management platform 102, the cloud 104, the property owner GUI 106, the general contractor GUI 108, the sub-contractor GUI 110, the base module 112, the credit network database 114, the credit offer module 116, at least one of the one or more sub-contractors 118-1 . . . 118-N, the input module 202, the filter module 204, the risk module 206, the credit network database 300, the data related to the client received in operation 402, the offer details received in operation 404, the team data received in operation 605, credit score(s) associated with the contractor(s) (e.g., general contractor(s) and/or sub-contractor(s)) associated with a project, credit score(s) associated with an owner (e.g., property owner) associated with the project, a payment history associated with one or more prior projects worked on by subset(s) of the team (e.g., by at least one contractor in the team), a level of timeliness (e.g., ahead of schedule, on schedule, or late) of work associated with one or more prior projects worked on by subset(s) of the team (e.g., by at least one contractor in the team), a level of completion (e.g., finished or unfinished, for instance with a percentage or proportion of completion) associated with one or more prior projects worked on by subset(s) of the team (e.g., by at least one contractor in the team), an extent of repayment (e.g., repaid, partially repaid, unpaid) of at least one prior loan associated with at least one prior project worked on by subset(s) of the team (e.g., by at least one contractor in the team), a timeliness of repayment (e.g., early, on time, late) of at least one prior loan associated with at least one prior project worked on by subset(s) of the team (e.g., by at least one contractor in the team), one or more instances of loan delinquency associated with the at least one prior loan associated with at least one prior project worked on by subset(s) of the team (e.g., by at least one contractor in the team), other information associated with the team data 510, any other type of information (e.g., associated with a project and/or contractor and/or team) discussed herein, or any combination thereof.

The output(s) 530 generated by the ML model(s) 525 in response to input of the input(s) 505 (e.g., in response to the team data 510) into the ML model(s) 525 can include one or more confidence score(s) 535. The ML model(s) 525 can generate the confidence score(s) 535 based on the team data 510 and/or other types of input(s) 505. The confidence score(s) 535 can include, for instance, a score based on one or more of the credit scores in the credit network database 300, the confidence score of operation 408, the confidence score generated in operation 610, or a combination thereof. In some examples, the confidence score can be based on credit score(s) associated with the contractor(s) (e.g., general contractor(s) and/or sub-contractor(s)) associated with a project, credit score(s) associated with an owner (e.g., property owner) associated with the project, a payment history associated with one or more prior projects worked on by subset(s) of the team (e.g., by at least one contractor in the team), a level of timeliness (e.g., ahead of schedule, on schedule, or late) of work associated with one or more prior projects worked on by subset(s) of the team (e.g., by at least one contractor in the team), a level of completion (e.g., finished or unfinished, for instance with a percentage or proportion of completion) associated with one or more prior projects worked on by subset(s) of the team (e.g., by at least one contractor in the team), an extent of repayment (e.g., repaid, partially repaid, unpaid) of at least one prior loan associated with at least one prior project worked on by subset(s) of the team (e.g., by at least one contractor in the team), a timeliness of repayment (e.g., early, on time, late) of at least one prior loan associated with at least one prior project worked on by subset(s) of the team (e.g., by at least one contractor in the team), one or more instances of loan delinquency associated with the at least one prior loan associated with at least one prior project worked on by subset(s) of the team (e.g., by at least one contractor in the team), other information associated with the team data 510, or a combination thereof. In some examples, the confidence score(s) 535 can be used as input(s) 505 to the ML model(s) 525 (e.g., as the confidence score(s) 515) for generating future confidence score(s) and/or other output(s) 530. In some examples, the confidence score(s) 515 in the input(s) 505 represent previously-generated scores that are input into the ML model(s) 525 to generate further confidence score(s) 535, the recommended offer(s) 537, the customized content 540, and/or other output(s) 530.

The output(s) 530 generated by the ML model(s) 525 in response to input of the input(s) 505 (e.g., in response to the team data 510 and/or the confidence score(s) 515) into the ML model(s) 525 can include one or more recommended offer(s) 537. The ML model(s) 525 can generate the recommended offer(s) 537 based on the team data 510, the confidence score(s) 515, and/or other types of input(s) 505. In some examples, based on receipt of the input(s) 505, the ML model(s) 525 can select the recommended offer(s) 537 from a predefined list of possible recommended offer(s). The recommended offer(s) can include, for instance, the offer received at operation 410, the offer decided about at operation 412, the offer for materials financing prompted at operation 414, the offer for materials financing prompted at operation 416, the at least one recommended offer generated in operation 615, or a combination thereof. Examples of the recommended offer(s) 537 can include an offer to get prequalified (e.g., at the time of start of a new project, at invitation to bid, at bid submission, or at contract award), an offer for materials financing (e.g., at a time of request for materials or materials procurement), an offer for pay advance (e.g., at a time of pay application submission or approval), an offer for credit, an offer for a loan, or a combination thereof.

In some examples, the recommended offer(s) 537 can be used as input(s) 505 to the ML model(s) 525 (e.g., as the recommended offer(s) 517) for generating future recommended offer(s) 537 and/or other output(s) 530. In some examples, the recommended offer(s) 517 in the input(s) 505 represent previously-generated recommended offer(s) that are input into the ML model(s) 525 to generate further recommended offer(s) 537, customized content 540, and/or other output(s) 530.

The output(s) 530 generated by the ML model(s) 525 in response to input of the input(s) 505 (e.g., in response to the team data 510 and/or the confidence score(s) 515 and/or the recommended offer(s) 517) into the ML model(s) 525 can include customized content 540. The ML model(s) 525 can generate the customized content 540 based on the team data 510, the confidence score(s) 515, the recommended offer(s) 517, and/or other types of input(s) 505. In some examples, based on receipt of the input(s) 505, the ML model(s) 525 can generate the customized content 540 using generative artificial intelligence (AI) content generation techniques, for instance by generating text using at least one LLM, a transformer model, a GAN, a VAE, and/or any other type of ML model discussed above as part of the ML model(s) 525, by generating text, image(s), audio, video(s), or a combination thereof. The customized content 540 generated by the ML model(s) 525 in response to input of the input(s) 505 to the ML model(s) 525 can include, for example, customized text and/or images to output in an alert that identifies the confidence score(s) (e.g., confidence score(s) 515, confidence score(s) 535) through an interface of a user device and/or customized text and/or images to output in an alert that identifies the recommended offer(s) (e.g., recommended offer(s) 517, recommended offer(s) 537) through an interface of the user device. In some examples, the customized content 540 can be based on the team data 510, the confidence score(s) (e.g., confidence score(s) 515, confidence score(s) 535), the recommended offer(s) (e.g., recommended offer(s) 517, recommended offer(s) 537), other input(s) 505, other output(s) 530, insights based on any of these, summaries of any of these, or combinations thereof.

In some examples, the recommendation system that includes the ML engine 520 and/or ML model(s) 525 adds the customized content 540 to a data structure, such as a data structure in the cloud 104, the credit network database 114, the credit network database 300, or another data structure. In some examples, the customized content 540 can be used as input(s) 505 to the ML model(s) 525 for generating future customized content 540 and/or other output(s) 530.

In some examples, the recommendation system repeats the process 500 multiple times to generates the output(s) 530 in multiple passes, using some of the output(s) 530 from earlier passes as some of the input(s) 505 in later passes. For instance, in an illustrative example, in a first pass, the ML model(s) 525 can generate the confidence score(s) 535 based on input of the team data 510 into the ML model(s) 525. In a second pass, the ML model(s) 525 can identify the recommended offer(s) 537 (e.g., select the recommended offer(s) 537 from a list of pre-determined possible recommended offer(s), or generate the recommended offer(s) 537) based on input of the team data 510 and/or the confidence score(s) 535 from the first pass (as the confidence score(s) 515) into the ML model(s) 525. In a third pass, the ML model(s) 525 can generate customized content—for instance, customized text and/or image data for an alert that recommends the recommended offer(s) to the user device based on the confidence score(s)—based on input of the team data 510, the confidence score(s) 535 from the first pass (as the confidence score(s) 515), and/or the recommended offer(s) 537 from the second pass (as the recommended offer(s) 517) into the ML model(s) 525.

In some examples, the recommendation system includes one or more feedback engine(s) 545 that generate and/or provide feedback 550 about the output(s) 530. In some examples, the feedback 550 indicates how well the output(s) 530 align to corresponding expected output(s), how well the output(s) 530 serve their intended purpose, or a combination thereof. In some examples, the feedback engine(s) 545 include loss function(s), reward model(s) (e.g., other ML model(s) that are used to score the output(s) 530), discriminator(s), error function(s) (e.g., in backpropagation), user interface feedback received via a user interface from a user, or a combination thereof. In some examples, the feedback 550 can include one or more alignment score(s) that score a level of alignment between the output(s) 530 and the expected output(s) and/or intended purpose.

The ML engine 520 of the recommendation system can update (further train) the ML model(s) 525 based on the feedback 550 to perform an update 555 of the ML model(s) 525 based on the feedback 550. In some examples, the feedback 550 includes positive feedback, for instance indicating that the output(s) 530 closely align with expected output(s) and/or that the output(s) 530 serve their intended purpose. In some examples, the feedback 550 includes negative feedback, for instance indicating a mismatch between the output(s) 530 and the expected output(s), and/or that the output(s) 530 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback. In response to positive feedback in the feedback 550, the ML engine 520 can perform the update 555 to update the ML model(s) 525 to strengthen and/or reinforce weights associated with generation of the output(s) 530 to encourage the ML engine 520 to generate similar output(s) 530 given similar input(s) 505. In response to negative feedback in the feedback 550, the ML engine 520 can perform the update 555 to update the ML model(s) 525 to weaken and/or remove weights associated with generation of the output(s) 530 to discourage the ML engine 520 from generating similar output(s) 530 given similar input(s) 505.

In some examples, the ML engine 520 can also perform an initial training of the ML model(s) 525 before the ML model(s) 525 are used to generate the output(s) 530 based on the input(s) 505. During the initial training, the ML engine 520 can train the ML model(s) 525 based on training data 560. In some examples, the training data 560 includes examples of input(s) (of any input types discussed with respect to the input(s) 505), output(s) (of any output types discussed with respect to the output(s) 530), and/or feedback (of any feedback types discussed with respect to the feedback 550).

In an illustrative example, the training data 560 can include team data (as in the team data 510), a confidence score that corresponds to the team data (as in the confidence score(s) 535), and feedback indicating whether the confidence score is a good or bad confidence score given the team data. In a second illustrative example, the training data 560 can include team data (as in the team data 510) and/or confidence score(s) (as in the confidence score(s) 515), a recommended offer that corresponds to the team data and/or confidence score(s) (as in the recommended offer 537), and feedback indicating whether the recommended offer is a good or bad recommended offer given the team data and/or confidence score(s). In a third illustrative example, the training data 560 can include team data (as in the team data 510) and/or confidence score(s) (as in the confidence score(s) 515) and/or recommended offer(s) (as in the recommended offer(s) 517), customized content that corresponds to the team data and/or confidence score(s) and/or recommended offer(s) (as in the customized content 540), and feedback indicating whether the customized content is good or bad customized content given the team data and/or confidence score(s) and/or recommended offer(s). In some cases, positive feedback in the training data 560 can be used to perform positive training, to encourage the ML model(s) 525 to generate output(s) similar to the output(s) in the training data given input of the corresponding input(s) in the training data. In some cases, negative feedback in the training data 560 can be used to perform negative training, to discourage the ML model(s) 525 from generate output(s) similar to the output(s) in the training data given input of the corresponding input(s) in the training data.

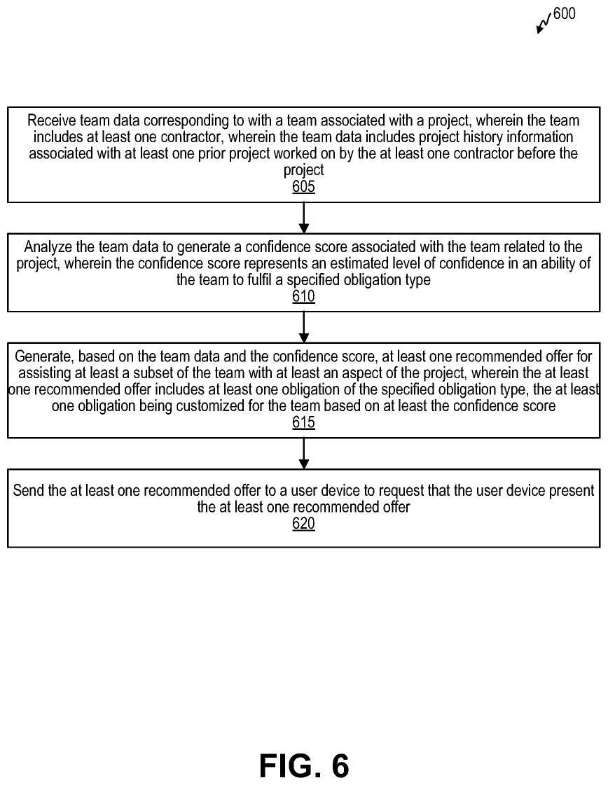

FIG. 6 illustrates a flowchart for a process 600 for team analysis and recommendation. The process 600 is performed using a recommendation system. The recommendation system can include, for instance, the system 100, the construction management platform 102, the cloud 104, the property owner GUI 106, the general contractor GUI 108, the sub-contractor GUI 110, the base module 112, the credit network database 114, the credit offer module 116, at least one of the one or more sub-contractors 118-1 . . . 118-N, the input module 202, the filter module 204, the risk module 206, the credit network database 300, a system that performs the process 400, the recommendation system that performs the process 500 of FIG. 5, the ML engine 520, the ML model(s) 525, the feedback engine(s) 545, the computing system 700, the processor 710, an output device 735, a communication interface 740, an input device 745, a display, a speaker, an apparatus, a system, a device, a processor that executes instructions stored in a non-transitory computer-readable storage medium (e.g., a memory), any other system(s) or device(s) discussed herein, any component(s) and/or subsystem(s) of any of the previously-listed systems, or a combination thereof.

At operation 605, the recommendation system (or a component thereof) is configured to, and can, receive team data corresponding to a team associated with a project. The team includes at least one contractor. The team data includes project history information associated with at least one prior project worked on by the at least one contractor before the project.

Examples of the team data include information associated with (and/or stored on) the construction management platform 102, the cloud 104, the property owner GUI 106, the general contractor GUI 108, the sub-contractor GUI 110, the base module 112, the credit network database 114, the credit offer module 116, at least one of the one or more sub-contractors 118-1 . . . 118-N, the input module 202, the filter module 204, the risk module 206, the credit network database 300, the data related to the client received in operation 402, the offer details received in operation 404, the team data 510, credit score(s) associated with the contractor(s) (e.g., general contractor(s) and/or sub-contractor(s)) associated with a project, credit score(s) associated with an owner (e.g., property owner) associated with the project, a payment history associated with one or more prior projects worked on by subset(s) of the team (e.g., by at least one contractor in the team), a level of timeliness (e.g., ahead of schedule, on schedule, or late) of work associated with one or more prior projects worked on by subset(s) of the team (e.g., by at least one contractor in the team), a level of completion (e.g., finished or unfinished, for instance with a percentage or proportion of completion) associated with one or more prior projects worked on by subset(s) of the team (e.g., by at least one contractor in the team), an extent of repayment (e.g., repaid, partially repaid, unpaid) of at least one prior loan associated with at least one prior project worked on by subset(s) of the team (e.g., by at least one contractor in the team), a timeliness of repayment (e.g., early, on time, late) of at least one prior loan associated with at least one prior project worked on by subset(s) of the team (e.g., by at least one contractor in the team), one or more instances of loan delinquency associated with the at least one prior loan associated with at least one prior project worked on by subset(s) of the team (e.g., by at least one contractor in the team), other information associated with the team data 510, any other type of information (e.g., associated with a project and/or contractor and/or team) discussed herein, or any combination thereof.

In some aspects, the project history information identifies a payment history associated with at least one payment made by the at least one contractor in association with the at least one prior project, a timeliness history indicative of a level of timeliness associated with work by the at least one contractor on the at least one prior project, a completion history indicative of a level of completion associated with work by the at least one contractor on the at least one prior project, or a combination thereof.

At operation 610, the recommendation system (or a component thereof) is configured to, and can, analyze the team data to generate a confidence score associated with the team related to the project. The confidence score represents an estimated level of confidence in an ability of the team to fulfill a specified obligation type.

Examples of the confidence score include a score based on one or more of the credit scores in the credit network database 300, the confidence score of operation 408, the confidence score(s) 515, the confidence score(s) 535, or a combination thereof. In some examples, the confidence score can be based on credit score(s) associated with the contractor(s) (e.g., general contractor(s) and/or sub-contractor(s)) associated with a project, credit score(s) associated with an owner (e.g., property owner) associated with the project, a payment history associated with one or more prior projects worked on by subset(s) of the team (e.g., by at least one contractor in the team), a level of timeliness (e.g., ahead of schedule, on schedule, or late) of work associated with one or more prior projects worked on by subset(s) of the team (e.g., by at least one contractor in the team), a level of completion (e.g., finished or unfinished, for instance with a percentage or proportion of completion) associated with one or more prior projects worked on by subset(s) of the team (e.g., by at least one contractor in the team), an extent of repayment (e.g., repaid, partially repaid, unpaid) of at least one prior loan associated with at least one prior project worked on by subset(s) of the team (e.g., by at least one contractor in the team), a timeliness of repayment (e.g., early, on time, late) of at least one prior loan associated with at least one prior project worked on by subset(s) of the team (e.g., by at least one contractor in the team), one or more instances of loan delinquency associated with the at least one prior loan associated with at least one prior project worked on by subset(s) of the team (e.g., by at least one contractor in the team), other information associated with the team data, or a combination thereof.

In some examples, to identify the confidence score (at operation 610), the recommendation system (or a component thereof) is configured to, and can, select the confidence score from a predetermined list of possible confidence scores based on the team data and/or information about the project. In some examples, to identify the confidence score (at operation 610), the recommendation system (or a component thereof) is configured to, and can, generate the confidence score to be customized to the team and/or the project based on the team data and/or information about the project.

In some aspects, the analyzing of the team data to generate the confidence score (as in operation 610) includes processing the team data (e.g., the team data 510 of the input(s) 505) using at least one trained machine learning model (e.g., the ML model(s) 525) to generate a model output (e.g., output(s) 530) indicative of the confidence score (e.g., as the confidence score(s) 535). In some aspects, the recommendation system (or a component thereof) is configured to, and can: train the at least one trained machine learning model further (e.g., the update 555) based on the confidence score and information identifying at least one interaction with the at least one recommended offer (e.g., based on the feedback 550).

At operation 615, the recommendation system (or a component thereof) is configured to, and can, generate, based on the team data and the confidence score, at least one recommended offer for assisting at least a subset of the team with at least an aspect of the project. The at least one recommended offer includes at least one obligation of the specified obligation type. The at least one obligation is customized for the team based on at least the confidence score.

Examples of the at least one recommended offer include the offer received at operation 410, the offer decided about at operation 412, the offer for materials financing prompted at operation 414, the offer for materials financing prompted at operation 416, the recommended offer(s) 517, the recommended offer(s) 537, an offer to get prequalified (e.g., at the time of start of a new project, at invitation to bid, at bid submission, or at contract award), an offer for materials financing (e.g., at a time of request for materials or materials procurement), an offer for pay advance (e.g., at a time of pay application submission or approval), an offer for credit, an offer for a loan, or a combination thereof.

In some examples, to identify the at least one recommended offer (at operation 615), the recommendation system (or a component thereof) is configured to, and can, select the at least one recommended offer from a predetermined list of possible offers based on the team data and/or the confidence score. In some examples, to identify the at least one recommended offer (at operation 615), the recommendation system (or a component thereof) is configured to, and can, generate the at least one recommended offer to be customized to the team and/or the project based on the team data and/or the confidence score.

In some aspects, the identifying of the recommended offer associated with the at least one recommended offer (as in operation 615) includes processing the team data (e.g., the team data 510 of the input(s) 505) and/or the confidence score (e.g., using at least one trained machine learning model to generate a model output indicative of the at least one recommended offer. In some aspects, the recommendation system (or a component thereof) is configured to, and can: train the at least one trained machine learning model further (e.g., the update 555) based on the at least one recommended offer and information identifying at least one interaction with the at least one recommended offer (e.g., based on the feedback 550).

In some aspects, the specified obligation type is associated with repayment of a loan. In some aspects, the project history information identifies loan information associated with at least one prior loan corresponding to the at least one prior project, and the confidence score is based on the loan information. In some aspects, the loan information includes at least one of an extent of repayment of the at least one prior loan, a timeliness of the repayment of the at least one prior loan, at least one instance of loan delinquency associated with the at least one prior loan, or a combination thereof.

At operation 620, the recommendation system (or a component thereof) is configured to, and can, send the at least one recommended offer to a user device to request that the user device present the at least one recommended offer.

In some aspects, the recommendation system (or a component thereof) is configured to, and can: monitor the team data over a time period to identify a change to the team data that occurs during the time period, and adjust the confidence score based on the change to the team data. In some aspects, the change to the team data includes addition of at least one second contractor to the team. In some aspects, the change to the team data includes removal of the at least one contractor from the team. For instance, the change to the team data can include the at least one contractor being replaced with the at least one second contractor. In some aspects, the recommendation system (or a component thereof) is configured to, and can: adjust the at least one recommended offer based on the change to the confidence score. In some aspects, the recommendation system (or a component thereof) is configured to, and can: monitor the team data over a time period to identify a change to the team data that occurs during the time period, and adjust the at least one recommended offer based on the change to the team data.

In some aspects, the recommendation system (or a component thereof) is configured to, and can: monitor the project over a time period to identify a change to the project that occurs during the time period, and adjust the confidence score based on the change to the project. In some aspects, the recommendation system (or a component thereof) is configured to, and can: adjust the at least one recommended offer based on the change to the confidence score. In some aspects, the change to the project includes a change in a stage that the project is in along a project timeline associated with the project. In some aspects, the change to the project includes a setback in the project. In some aspects, the recommendation system (or a component thereof) is configured to, and can: monitor the project over a time period to identify a change to the project that occurs during the time period, and adjust the at least one recommended offer based on the change to the project.

In the present disclosure, the methods disclosed may be implemented as sets of instructions or software readable by a device. Further, it is understood that the specific order or hierarchy of steps or operations in the methods disclosed are instances of example approaches. Based upon design preferences, it is understood that the specific order or hierarchy of steps or operations in the methods can be rearranged while remaining within the disclosed subject matter. The accompanying method claims present elements of the various steps in a sample order, and are not necessarily meant to be limited to the specific order or hierarchy presented.

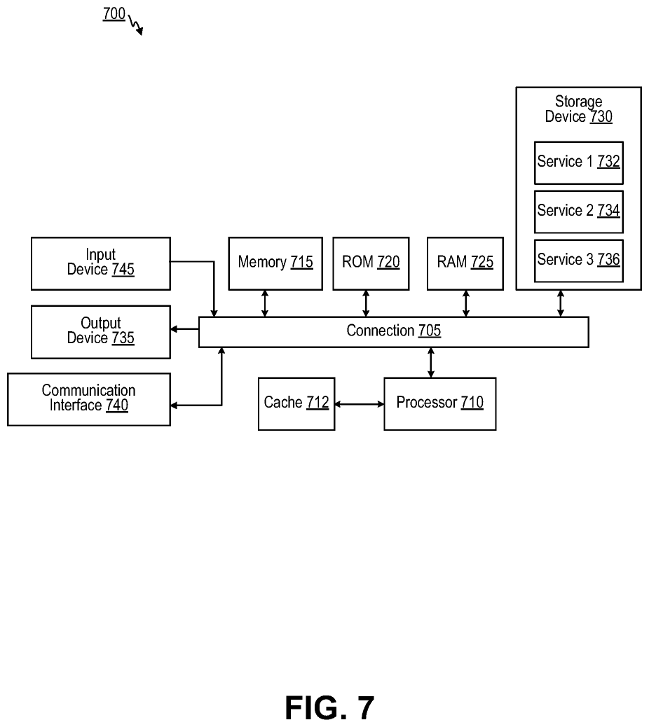

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some aspects, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

The disclosures of each and every patent, patent application, and publication cited herein are hereby incorporated herein by reference in their entirety. While this disclosure has been disclosed with reference to specific embodiments, it is apparent that other embodiments and variations of this disclosure may be devised by others skilled in the art without departing from the true spirit and scope of the disclosure. It will be appreciated by those skilled in the art that changes could be made to the exemplary embodiments described above without departing from the broad inventive concept thereof. It is to be understood, therefore, that this disclosure is not limited to the particular embodiments disclosed, but it is intended to cover modifications within the spirit and scope of the subject disclosure as disclosed above.

What is claimed is:

1. A method for team analysis and recommendation, the method comprising:
receiving team data corresponding to a team associated with a project, wherein the team includes at least one contractor, wherein the team data includes project history information associated with at least one prior project worked on by the at least one contractor before the project;
analyzing the team data to generate a confidence score associated with the team related to the project, wherein the confidence score represents an estimated level of confidence in an ability of the team to fulfill a specified obligation type;
identify, based on the team data and the confidence score, at least one recommended offer for assisting at least a subset of the team with at least an aspect of the project, wherein the at least one recommended offer includes at least one obligation of the specified obligation type, the at least one obligation being customized for the team based on at least the confidence score; and
sending the at least one recommended offer to a user device to request that the user device present the at least one recommended offer.

2. The method of claim 1, wherein the project history information identifies a payment history associated with at least one payment made by the at least one contractor in association with the at least one prior project.

3. The method of claim 1, wherein the project history information identifies a timeliness history indicative of a level of timeliness associated with work by the at least one contractor on the at least one prior project.

4. The method of claim 1, wherein the project history information identifies a completion history indicative of a level of completion associated with work by the at least one contractor on the at least one prior project.

5. The method of claim 1, wherein the specified obligation type is associated with repayment of a loan.

6. The method of claim 1, wherein the project history information identifies loan information associated with at least one prior loan corresponding to the at least one prior project, wherein the confidence score is based on the loan information.

7. The method of claim 6, wherein the loan information includes at least one of an extent of repayment of the at least one prior loan, a timeliness of the repayment of the at least one prior loan, or at least one instance of loan delinquency associated with the at least one prior loan.

8. The method of claim 1, further comprising:
monitoring the team data over a time period to identify a change to the team data that occurs during the time period; and
adjusting the confidence score based on the change to the team data.

9. The method of claim 8, wherein the change to the team data includes addition of at least one second contractor to the team.

10. The method of claim 8, wherein the change to the team data includes removal of the at least one contractor from the team.

11. The method of claim 8, further comprising:
adjusting the at least one recommended offer based on the change to the confidence score.

12. The method of claim 1, further comprising:
monitoring the project over a time period to identify a change to the project that occurs during the time period; and
adjusting the confidence score based on the change to the project.

13. The method of claim 12, further comprising:
adjusting the at least one recommended offer based on the change to the confidence score.

14. The method of claim 12, wherein the change to the project includes a change in a stage that the project is in along a project timeline associated with the project.

15. The method of claim 12, wherein the change to the project includes a setback in the project.

16. The method of claim 1, wherein the analyzing of the team data to generate the confidence score includes processing the team data using at least one trained machine learning model to generate a model output indicative of the confidence score.

17. The method of claim 16, further comprising:
training the at least one trained machine learning model further based on the confidence score and information identifying at least one interaction with the at least one recommended offer.

18. The method of claim 1, wherein the identifying of the recommended offer associated with the at least one recommended offer includes processing the team data and the confidence score using at least one trained machine learning model to generate a model output indicative of the at least one recommended offer.

19. The method of claim 18, further comprising:
training the at least one trained machine learning model further based on the at least one recommended offer and information identifying at least one interaction with the at least one recommended offer.

20. A system for team analysis and recommendation, the system comprising:
at least one memory; and
at least one processor, wherein execution of instructions stored in the at least one memory by the at least one processor causes the at least one processor to:
receive team data corresponding to a team associated with a project, wherein the team includes at least one contractor, wherein the team data includes project history information associated with at least one prior project worked on by the at least one contractor before the project;
analyze the team data to generate a confidence score associated with the team related to the project, wherein the confidence score represents an estimated level of confidence in an ability of the team to fulfill a specified obligation type;
identify, based on the team data and the confidence score, at least one recommended offer for assisting at least a subset of the team with at least an aspect of the project, wherein the at least one recommended offer includes at least one obligation of the specified obligation type, the at least one obligation being customized for the team based on at least the confidence score; and
send the at least one recommended offer to a user device to request that the user device present the at least one recommended offer.
